(19) United States
(12) Patent Application Publication
(10) Pub. No.: US 2025/0367914 A1
(43) Pub. Date: Dec. 4, 2025

(54) FLEXIBLE FILM HAVING PAPER-LIKE TEXTURE FOR VERTICAL FORM FILL SEAL PACKAGING

(71) Applicant: PROAMPAC HOLDINGS INC., Cincinnati, OH (US)

(72) Inventor: Redouane Boutrouka, Terrebonne (CA)

(21) Appl. No.: 19/219,133

(22) Filed: May 27, 2025

Related U.S. Application Data
(60) Provisional application No. 63/652,804, filed on May 29, 2024.

(51) Int. Cl. B32B 27/08; B32B 27/30; B32B 27/32; B32B 27/34; B32B 27/36; B65D 75/00

(52) U.S. Cl. CPC B32B 27/08; B32B 27/306; B32B 27/32; B32B 27/34; B32B 27/36; B65D 75/008; B32B 2250/24; B32B 2255/10; B32B 2255/26; B32B 2307/31; B32B 2307/4023; B32B 2307/538; B32B 2307/748; B32B 2439/46

(57) ABSTRACT

A packaging film comprises an outer layer formed of a heat-scalable polymer. A polyolefin-based sealant layer laminated to an interior facing surface of the outer layer. A varnish coating layer is disposed on an exterior facing surface of the outer layer, the varnish coating layer configured to impart a tactile feel of paper to the outer layer.

### CROSS-REFERENCE TO RELATED APPLICATION

This application claims the priority benefit of U.S. provisional patent application No. 63/652,804 filed May 29, 2024. The aforementioned application is incorporated herein by reference in its entirety.

### BACKGROUND

The present disclosure relates to flexible packaging films and, in particular, to polymeric film webs wherein the outer surface has a paper-like tactile feel which are suitable for forming packages on a vertical form fill seal machine. In embodiments, the present disclosure relates to polymeric film webs having a paper-like tactile feel which are suitable for forming bottom gusseted stand up pouches on a vertical form fill machine.

Varnish coatings are known which can be applied to surfaces to mimic the tactile properties of paper when touched or handled. Such varnishes enhance the tactile experience and provide a premium feel to the products. However, because such varnishes increase the surface roughness, frictional forces between the coated surface and other surfaces is increased. This increased friction, in turn, can impede the efficient performance of such packaging films on certain packaging equipment.

Vertical form fill seal (VFFS) machines are automated packaging systems used in various industries to form, fill, and seal products into packages such as bags or pouches. Typically, the machine starts with a roll of flat, flexible packaging material which is drawn into the machine where it is shaped into a vertical tube by passing it over a forming collar shoulder which guides the film into a vertical position where it is wrapped around a forming tube. The longitudinal edges of the material are then sealed vertically using vertical sealing jaws to create a continuous tube. Once the tube is formed, the product to be packaged is dispensed into the tube from above through the forming tube using a filling mechanism which is synchronized with the bag or pouch forming process. After the product is filled into the tube, the machine seals the top of the filled bag and the bottom of the next bag simultaneously using horizontal sealing jaws, which may include an integral cutter for cutting the sealed bags from the continuous tube for further processing or distribution.

As the flat web material is drawn over the forming collar, the exterior surface of the film slides over the forming collar. Films used in VFFS machines are typically designed with smooth surfaces that facilitate smooth sliding movement over the forming collar to prevent that issues could arise if the film's outer surface is not sufficiently slippery, such as jams, uneven forming, film tension problems, tracking issues, registration issues, damage to the film, and so forth. Due to the increased roughness and friction associated with varnish coatings that provide paper-like tactile properties, they have not been good candidates for running on VFFS machines.

Another challenge associated with VFFS machines resides in forming packaging articles that are more complex than standard pillow packs, such as standup pouches with bottom gusset panels. However, forming more intricate, such as standup pouches with bottom gusset panels, presents an increased level of complexity. Adapting VFFS machines to handle these complex packs requires additional processing steps and specialized hardware.

For example, a VFFS machine adapted for producing a bottom gusseted stand up pouch requires mechanisms for gusset formation and enhanced sealing techniques to ensure package integrity. In producing bottom gusseted stand up pouch, it is common to seal or tack the edges of the gusseted bottom together to maintain the pouch's shape and stability.

However, because the gusset pleat is folded such that outer film surface on one side of the fold line faces the outer film surface on the other side of the fold line. As shown in FIG. 6, because the outer film surface is typically not sealable, a gusset punch may be used to create aligned and facing cutouts or notches 10 along the lateral edges of the gusset panel 20 on opposite sides of the gusset fold line prior to sealing. These cutouts or notches expose the sealing surfaces of the pouch front and back panels, enabling them to be sealed, thereby pinning the edges together in the bottom gusset region. However, this solution is only available in VFFS machines equipped with a gusset punch.

The present disclosure contemplates a new and improved polymer film packaging structure which overcomes the above-referenced problems and others.

### SUMMARY

In one aspect, polymer film packaging structures are provided.

In another aspect, packaging articles formed from a web of the packaging structures herein are provided.

In another aspect, a method for making polymer film packaging structure is provided.

In another aspect, a method for making packaging articles is provided.

One advantage of the present development resides in its enhanced tactile properties, providing a feel similar to traditional paper packaging.

Another advantage of the present development resides in its good runability on VFFS equipment.

Another advantage of the present invention resides in its ability to be formed into a bottom gusseted stand up pouch on VFFS equipment that lacks a gusset punch.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is cross sectional view of a polymeric film structure in accordance with an exemplary embodiment.

FIG. 2 is front view of a packaging article formed of the film structure appearing in FIG. 1, in a flat configuration.

FIG. 3 is rear view of the packaging article appearing in FIG. 2, in a filled or expanded configuration.

FIG. 4 is bottom view of the packaging article appearing in FIG. 2, illustrating the tacked edges of the bottom gusset region.

FIG. 5 is a partial bottom view of a packaging article similar to the packaging article appearing in FIG. 2, but wherein the tacked edges of the bottom gusset region have been separated.

FIG. 6 is a partial bottom view of a prior art bottom gusseted stand up pouch illustrating cutouts in the bottom gusset panel to allow sealing the edges of the bottom gusset when the outer film surface is not heat-sealable.

FIG. 7 is an image of an exemplary VFFS machine configured for producing the packaging articles herein.

FIG. 8 is an image of the guiding and forming section of an exemplary VFFS.

FIG. 9 illustrates a method for calculating average roughness (Ra).

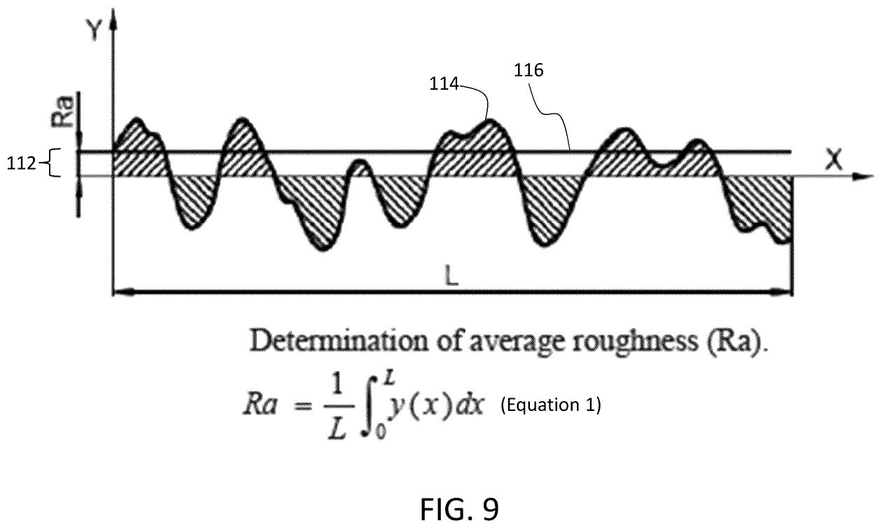

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

As used herein, the term “inner layer” refers to the layer of the film structure configured to face toward or contact the product. The term “outer layer” refers to the main polymer layer of the film structure opposite the inner layer and configured to face away from the product, excluding any surface coatings such as printed ink layers or varnish layers. The term “exterior layer” encompasses both the inner and outer layers. The term “intermediate layer” refers to any layer that is disposed between the inner and outer layers.

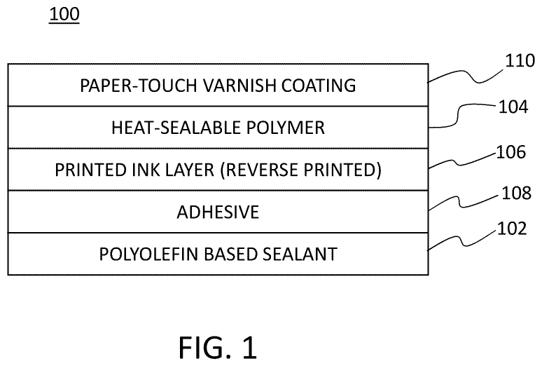

Referring now to the drawings, there appears in FIG. 1 a film structure 100 comprising a polyolefin-based sealant layer 102 and a heat-sealable outer layer 104. The polyolefin-based sealant layer 102 defines an interior surface of the film structure 100, i.e., the product contacting surface. In embodiments, the heat sealable outer layer 104 includes a printed ink layer 106 comprising graphics and other indicia. Because the printed material is disposed on the interior surface of the heat sealable outer layer 104, it is effected in a mirrored or reverse printed format. The polyolefin-based sealant layer 102 is laminated to the printed side of the heat-sealable outer layer 104 via an adhesive layer 108. A varnish coating layer is disposed on the exterior facing surface of the heat-sealable outer layer 104.

The polyolefin-based sealant layer 102 comprises a monolayer or multilayer structure. In certain embodiments, the polyolefin-based sealant layer 102 includes one or more gas barrier layers, such as an oxygen and/or water vapor barrier layer. In certain embodiments, polyolefin-based sealant layer 102 is formed of polyethylene (PE), polypropylene (PP), polyolefin blends, or polyolefin copolymers. In embodiments, polyolefin-based sealant layer 102 comprises low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cast polypropylene (CPP), ethylene-propylene copolymer (EPC), monoaxially- and biaxially-oriented polyolefins including without limitation biaxially oriented polypropylene (BOPP), and other polyolefin materials, including post-consumer recycled (PCR) polyolefins, as well as blends, coextrusions, and lamination of any of the foregoing, provided that at least the exterior most layer is a heat sealable polyolefin layer. In embodiments, the polyolefin-based sealant layer 102 may be a copolymer of polyethylene and polypropylene, such as an ethylene-propylene copolymer. In embodiments, the polyolefin-based sealant layer 102 may be a coextruded film with a barrier layer and optional tie resin layers as would be understood by persons skilled in the art. In embodiments, the barrier layer is selected from ethylene vinyl alcohol (EVOH) and polyamide (PA), such as nylon 6, nylon 66, nylon 6/66, and the like.

In certain embodiments, the polyolefin-based sealant layer 102 has a structure, wherein the tie resin layers are optional, as follows:
PE/tie resin/EVOH/tie resin/PE
PE/tic resin/PA/EVOH/PA/tie resin/PE
PE/PE/tic resin/PA/EVOH/PA/tie resin/PE/PE

The heat-sealable outer layer 104, which may be a monolayer or multilayer film, may be formed of any suitable polymer material. In certain embodiments, the heat-sealable outer layer 104 is formed of a heat-sealable homopolyester or copolyester, or an admixture thereof, including without limitation polyethylene terephthalate (PET) and polybutylene terephthalate (PBT).

In certain embodiments, the heat-sealable outer layer 104 is formed of a polyolefin material such as polyethylene, polypropylene, polyolefin blends, or polyolefin copolymers. In embodiments, polyolefin-based sealant layer 102 comprises low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cast polypropylene (CPP), ethylene-propylene copolymer (EPC), monoaxially- and biaxially-oriented polyolefins including without limitation biaxially oriented polypropylene (BOPP), and other polyolefin materials, including post-consumer recycled (PCR) polyolefins, as well as blends, coextrusions, and lamination of any of the foregoing, provided that at least the exterior most layer is a heat sealable polyolefin layer. In embodiments, the heat-sealable outer layer 104 may be a copolymer of polyethylene and polypropylene, such as an ethylene-propylene copolymer. In embodiments, the heat-sealable outer layer 104 may be a coextruded film with a barrier layer and optional tie resin layers as would be understood by persons skilled in the art. In embodiments, the barrier layer is selected from ethylene vinyl alcohol (EVOH) and polyamide (PA), such as nylon 6, nylon 66, nylon 6/66, and the like.

The reverse printed ink layer 106 may include one or more of inks, pigments, dyes, and the like, e.g., for providing one or more visible indica on the exterior of the structure 100. The ink layer 106 can be applied to the heat-sealable substrate 104 via any conventional printing method as would be understood by persons skilled in the art, including without limitation, using a rotogravure printing apparatus, flexographic printing apparatus, offset printing apparatus, digital printing apparatus, ink jet printing apparatus, and the like.

The adhesive layer 108 is disposed intermediate the printed side 106 of the heat-sealable outer layer 104 and the polyolefin based sealant ply 102 and adhesively laminates or bonds the polyolefin based sealant ply 102 to the heat-sealable outer layer 104. The adhesive layer 348 may be formed of any suitable adhesive including single component adhesives, two component adhesives, solvent-based adhesives, solventless adhesives, water-based adhesives, acrylic adhesives, electron beam lamination adhesives, and UV lamination adhesives, and the like, as would be understood by persons skilled in the art.

A varnish is coated onto the heat-sealable outer layer 104 to form the varnish coating layer 110. The varnish comprises one or more natural or synthetic resins dissolved or dispersed in one or more solvents. The varnish may be coated onto the heat-sealable outer layer 104 using any suitable method, including roll coating, blade over roll coating, spray coating, flexographic coating, gravure coating, and the like, followed by drying. In embodiments, the varnish coating layer is applied at a coating weight in the range of from about 0.2 g/m² to about 3 g/m², preferably from about 0.6 g/m² to about 1 g/m², more preferably from about 0.4 g/m² to about 0.8 g/m². Unless stated otherwise, all coating weights specified herein are dry coating weights.

The application of the varnish is controlled by various factors to achieve an average roughness (Ra) of the dried varnish coating in the range of from about 2 μm to about 8 μm to achieve a paper-like tactile quality while keeping a low coefficient of kinetic friction (μ_{K}). The average roughness of the varnish can be influenced by a number of coating parameters such as the viscosity and concentration of the varnish; in the case of a flexographic coating method, the volume, shape, and resolution of the anilox roll and the resolution and polymer type of the printing plate; and, in the case of a gravure coating method, the volume, shape, and resolution of the gravure cylinder, as can be determined without undue experimentation by persons skilled in the art guided by the present disclosure.

Ra values provided herein are determined according to the method described in “Method of Measure of Roughness of Paper Based on the Analysis of the Texture of Speckle Pattern,” Pino et al., Proc. of SPIE, Vol. 7387, 73871W-1-73871W-7, the entire contents of which are incorporated herein by reference. Briefly, Ra is a measure of the average height 112 between the roughness profile 114 and its mean line 116 as shown in FIG. 11 or the integral of the absolute value of the roughness profile height over the evaluation length, where L is the length of profile and y(x) is the height absolute value from the reference profile in point x (Equation 1).

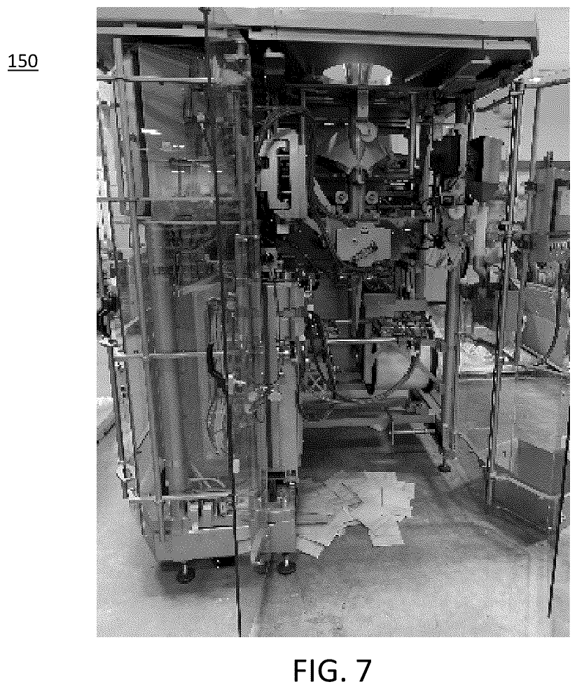

The coating 110 has a coefficient of kinetic friction (μ_{K}) which is sufficiently low to ensure runnability on vertical form fill seal equipment, especially the guiding and forming section, while having sufficient texture to provide a paper-like visual appearance and tactile feel. In embodiments, the coating 110 has a coefficient of kinetic friction in the range of from about 0.25 to about 0.45. Unless specified otherwise, all coefficients of kinetic friction provided in the present specification and claims are as measured by ASTM D1894. A coefficient of kinetic friction within this range has been found to allow the packaging film 100 on packaging machines which make sliding contact with the outer surface, such as vertical form fill seal (VFFS) machines. An exemplary VFFS machine 150 operable to run the film structure 100 to produce the pouches 120 appears in FIG. 7.

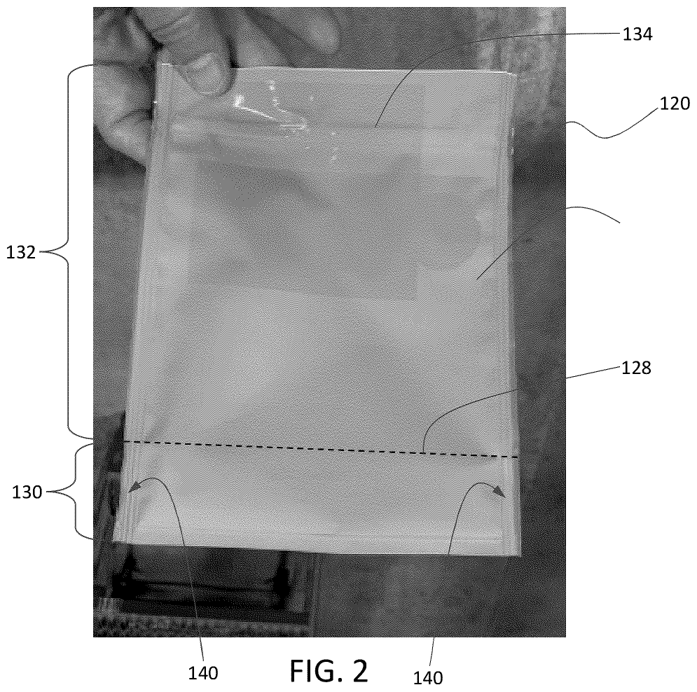

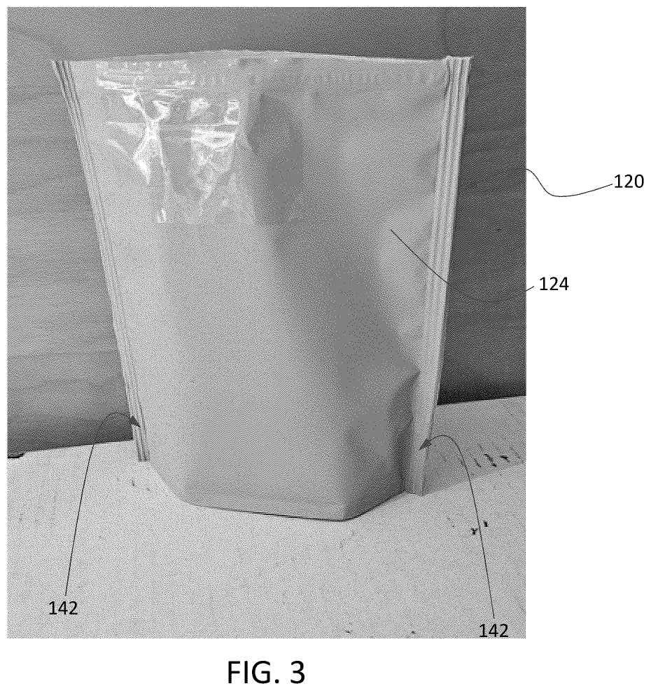

Referring now to FIGS. 2-4, an exemplary packaging article comprises a bottom-gusset stand up pouch 120 which comprises a front panel 122 and a rear panel 124 opposite the front panel 122. A bottom gusset panel 126 defines a folded pleat, which is folded upon itself in the flat configuration appearing in FIG. 2. The bottom gusset panel 126 is folded along a transverse fold line 128 and is disposed intermediate the front and rear panels 122, 124 at the bottom ends thereof.

The pouch 120 includes a gusset region 130 and a non-gusset region 132. In the gusset region 130, the gusset panel 126 is heat sealed to the front panel 122 on one side of the fold line 128 and to the rear panel 124 on the other side of the fold line 128. The opposing longitudinally extending edges of the gusset panel 126 on one side of the fold line 128 are heat sealed to the respective longitudinally extending edges of the front panel 122 within the gusset region 130. Likewise, the opposing longitudinally extending edges of the gusset panel 126 on the other side of the fold line 128 are heat sealed to the respective longitudinally extending edges of the rear panel 124 within the gusset region 130.

The transverse edge of the gusset panel 126 on one side of the fold line 128 is heat sealed to the lower transversely extending edge of the front panel 122. The transverse edge of the gusset panel 126 on the other side of the fold line 128 is heat sealed to the lower transversely extending edge of the rear panel 124 within the gusset region 130.

In the non-gusset region 132, the opposing longitudinally extending edges of the front panel 122 are heat sealed to the respective longitudinally extending edges of the rear panel 122. The upper transverse edges of the front and rear panels 122, 124 are heat sealed to form the top closure. In embodiments, a reclosure system 134 may be provided to reclose the top end of the pouch 120 after it has been opened. Exemplary reclosure systems include zippers (zip lock), sliders, press-to-close systems, adhesive strips, hook and loop systems, and the like.

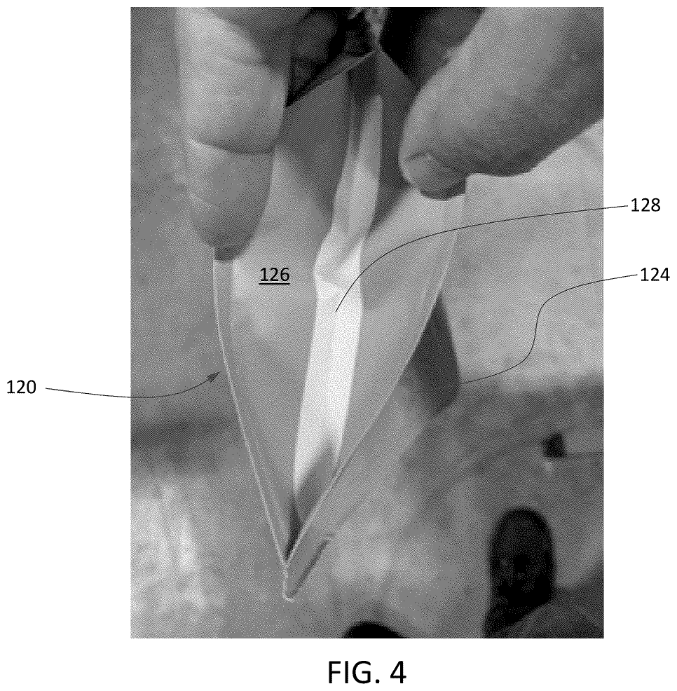

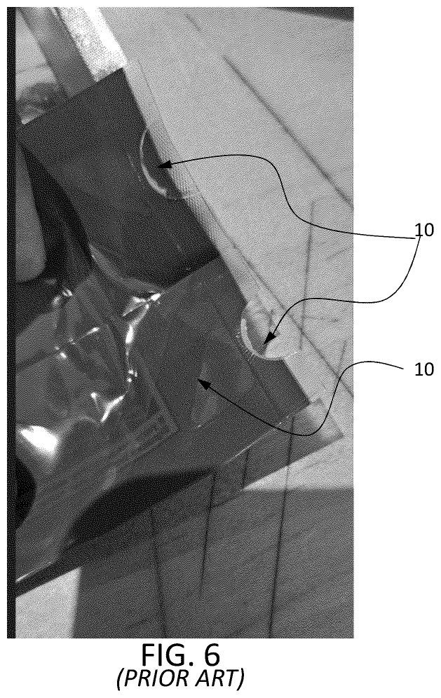

As best seen in FIG. 4, in the illustrated embodiment, because the outer ply 104 is comprises a heat-sealable polymer, the seal portion 140 which is created where the longitudinal edge of the gusset panel 126 is heat sealed to the front panel 122 on one side of the fold line 128 is further heat sealed to the seal portion 142 created where the longitudinal edge of the gusset panel 126 is sealed to the rear panel 124 on the other side of the fold line 128. By employing a heat-sealable outer ply 104, bottom gusseted standup pouches can be produced on VFFS machines that lack the ability to punch cutouts or notches 10 (see FIG. 6) in the gusset panel.

In embodiments, the heat-sealable outer ply 104 is heat sealable to itself to provide a gusset tack having a seal strength between the seal portions 140 and 142 which is greater than or equal to about 800 gram force/inch (gf/in). In embodiments, the heat-sealable outer ply 104 is heat sealable to itself to provide a gusset tack having a seal strength between the seal portions 140 and 142 which is in the range of from about 800 gram force/inch (gf/in) to about 3,000 gf/in, although higher seal strengths are possible. In embodiments, the heat-sealable outer ply 104 is heat sealable to itself to provide a gusset tack having a seal strength between the seal portions 140 and 142 which is in the range of from about 800 gram force/inch (gf/in) to about 1,500 gf/in. Unless specified otherwise, all seal strength values set forth in the present specification and claims are determined by ASTM F88/F88M, with seal conditions set at sealing temperature of 150° C., 0.4 second dwell time, and sealing pressure of 40 psi.

It has been found that having a seal strength which is at least 800 gf/in provides a gusset tack which passes a 5 oz. drop test from a height of 3 feet. It has further been found that having a seal strength which is greater than or equal to 800 gf/in provides a gusset tack which resists separation under vacuum stress conditions of 18 inches of mercury (inHg) for 30 seconds.

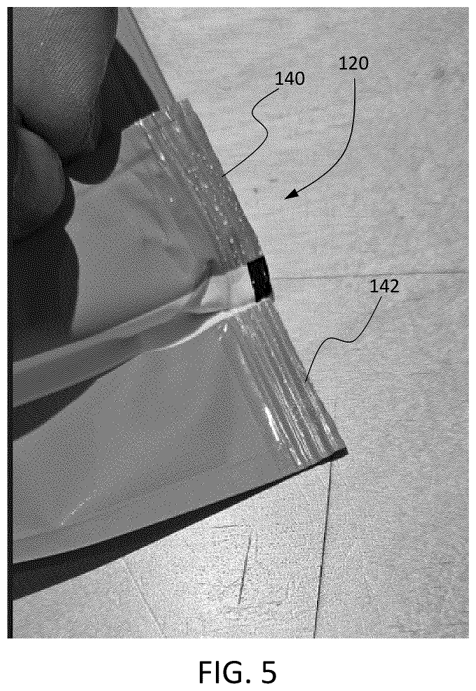

Referring to FIG. 5, there is shown a fragmentary view of a pouch 120 wherein the seal between the gusset portions 140 and 142 have been physically separated.

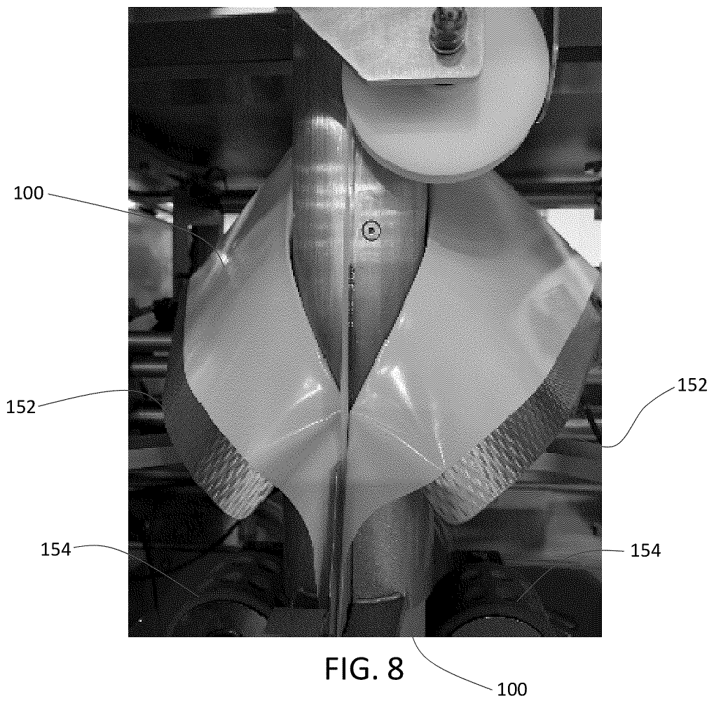

Referring now to FIG. 8, there is shown the forming assembly portion of the VFFS machine 150 (see FIG. 7), which illustrates the orientation of the film web 100 as is slides over the forming collar 152 when it is drawn over the forming tube via opposing film pull belts 154. As can be seen in FIG. 8, the web 100 is drawn over the forming collar 152 in an inverted orientation such that the outer, paper-touch varnish coating 100 slides over the surface of the forming collar 152. It has been found in reducing the present invention to practice that maintaining the average roughness (Ra) within the range of 2 μm to 8 μm and the coefficient of kinetic friction between 0.25 and 0.45 optimizes the runability of the film 100 on VFFS machines while also ensuring superior paper-like tactile qualities. Additionally, by providing a heat-sealable outer film ply 104 with self-adhesion properties under predetermined sealing conditions to achieve a seal strength in the range of from about 800 gf/in to 3000 gf/in enables successful outcomes in various testing protocols, such as drop tests and vacuum stress tests.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A packaging film, comprising:
an outer layer comprising a heat-sealable polymer;
a polyolefin-based sealant layer laminated to an interior facing surface of the outer layer; and
a varnish coating layer disposed on an exterior facing surface of the outer layer, the varnish coating layer configured to impart a tactile feel of paper to the outer layer.

2. The packaging film of claim 1, wherein the varnish coating layer has a coefficient of kinetic friction in the range of from about 0.25 o about 0.45.

3. The packaging film of claim 1, wherein the varnish coating layer has an average roughness in the range of from about 2 μm to about 8 μm.

4. The packaging film of claim 1, wherein the outer layer is configured to provide a heat seal strength of between about 800 gf/in and 3,000 gf/in when sealed to itself at a sealing temperature of 150° C., 0.4 second dwell time, and sealing pressure of 40 psi.

5. The packaging film of claim 1, wherein the heat-sealable outer layer comprises a polymer material selected from the group consisting of a polyester-based polymer and a polyolefin-based polymer.

6. The packaging film of claim 1, wherein the heat-sealable outer layer comprises a heat-sealable polyester-based polymer selected from the group consisting of homopolyesters, copolyesters, PET, PBT, and admixtures thereof.

7. The packaging film of claim 1, wherein the polyolefin based sealant layer comprises polyethylene.

8. The packaging film of claim 1, wherein the polyolefin based sealant layer comprises polypropylene.

9. The packaging film of claim 1, wherein the polyolefin based sealant layer is a multilayer film comprising a barrier layer and one or more optional tie resin layers.

10. The packaging film of claim 1, wherein the polyolefin based sealant layer is a coextruded multilayer film having a structure selected from the group consisting of:
PE/tie resin/EVOH/tie resin/PE;
PE/tie resin/PA/EVOH/PA/tie resin/PE; and
PE/PE/tie resin/PA/EVOH/PA/tie resin/PE/PE.

11. The packaging film of claim 1, further comprising a printed ink layer disposed in the interior facing surface of the outer layer.

12. The packaging film of claim 1, further comprising an adhesive layer intermediate the outer layer and the sealant layer.

13. The packaging film of claim 1, further comprising:
the varnish coating layer having a coefficient of kinetic friction in the range of from about 0.25 to about 0.45; and
the varnish coating layer having an average roughness in the range of from about 2 μm to about 8 μm.

14. The packaging film of claim 13, wherein the outer layer is configured to provide a heat seal strength of between about 800 gf/in and 3,000 gf/in when sealed to itself at a sealing temperature of 150° C., 0.4 second dwell time, and sealing pressure of 40 psi.

15. A packaging article formed from the packaging film of claim 1.

16. The packaging article of claim 15, wherein the packaging article is a bottom gusseted standup pouch.

17. The packaging article of claim 15, comprising:
a front panel and a rear panel each having respective opposing, axially-extending side edges and opposing, transversely extending top and bottom edges, the front and rear panels sealed to each other along their respective side edges;
a bottom gusset panel extending between the front and rear panels at the bottom edges thereof to form a base, the bottom gusset panel having opposing front and rear transverse edges, the bottom gusset panel sealed to the front and rear panels along the bottom gusset panel front and rear transverse edges and the front and rear panel bottom edges, respectively, the bottom gusset panel allowing the pouch to stand upright when filled with contents;
the bottom gusset panel comprising a transverse fold line, wherein opposing side edges of the bottom gusset panel on one side of the transverse fold line are sealed to respective aligned and overlapping portions of the front panel side edges to form opposing front side gusset seals, and wherein opposing side edges of the bottom gusset panel on the other side of the fold line are sealed to aligned and overlapping portions of the rear panel side edges to form opposing rear side gusset seals; and
wherein the opposing front side gusset seals are sealed to the respective opposing rear side gusset seals.

18. The packaging article of claim 15, wherein the bottom gusset panel comprises an exterior facing surface which is heat sealable directly to itself.

19. The packaging article of claim 15, wherein the packaging article is formed by a vertical form fill seal machine.
